(19) United States
(12) Patent Application Publication
(10) Pub. No.: US 2009/0249109 A1
(43) Pub. Date: Oct. 1, 2009

(54) STORAGE APPARATUS AND METHOD FOR STORING INTERNAL INFORMATION

(75) Inventor: Shunsuke Aoki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/402,263

(22) Filed: Mar. 11, 2009

(30) Foreign Application Priority Data
Mar. 26, 2008 (JP) 2008-080958

(51) Int. Cl. G06F 12/00; G06F 1/14

(52) U.S. Cl. 713/502; 711/156; 711/E12.001

(57) ABSTRACT

A storage apparatus stores data in a storage area, and includes a judgment unit and an internal information management unit. The judgment unit judges whether a preconfigured given condition is satisfied. The internal information management unit associates the satisfied preconfigured condition with internal information relating to an operation or a status of the storage apparatus and manages the condition and the internal information when the judgment unit judges that the given condition is satisfied.

### CROSS-REFERENCE TO RELATED APPLICATIONS

This application is based upon and claims the benefit of priority of prior Japanese Patent Application No. 2008-80958, filed on Mar. 26, 2008, the entire contents of which are incorporated herein by reference.

### FIELD

The embodiments discussed herein are related to a storage apparatus and a method for storing internal information.

### BACKGROUND

Conventionally, storage apparatuses such as hard disk drives gather information about temperatures in a main unit of a storage apparatus, a count of sectors from which data are read or on which data are written, the number of times the storage apparatus is recovered, the number of external shocks given to the storage apparatus, and the number of times a head is loaded or unloaded as internal information to analyze causes of errors.

However, the gathered internal information is totaled from when the storage apparatus is operated the first time to the present time (with respect to the temperature, the highest temperature and the lowest temperature from among the measured temperatures are stored.) Therefore, investigating a relation between the internal information and the errors is difficult. Consequently, correcting the errors based on the internal information is difficult.

### SUMMARY

According to an aspect of the embodiment, a storage apparatus storing data in a storage area includes a judgment unit and an internal information management unit. The judgment unit judges whether a preconfigured given condition is satisfied. The internal information management unit associates the satisfied preconfigured condition with internal information relating to an operation or a status of the storage apparatus and manages the condition and the internal information when the judgment unit judges that the given condition is satisfied.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating a structure of a HDD;

FIG. 2 is a block diagram illustrating the HDD and a host device connected with the HDD;

FIG. 3 is a flow chart illustrating a storing process of internal information;

FIG. 4 illustrates an internal information storage area;

FIG. 5 illustrates an example of stored internal information before an error correcting measure;

FIG. 6 illustrates an example of stored internal information after the error correcting measure;

FIG. 7 is a flow chart illustrating a storing process of the internal information according to a second embodiment;

FIG. 8 illustrates an example of the stored internal information according to the second embodiment;

FIG. 9 illustrates a comparative example of internal information.

### DESCRIPTION OF EMBODIMENTS

Preferred embodiments of the present invention will be explained with reference to the accompanying drawings.

In this application, hard disk drives (HDDs) are used as embodiments of the storage apparatus. However, the storage apparatus is not considered to be limited to the embodiments described in this application.

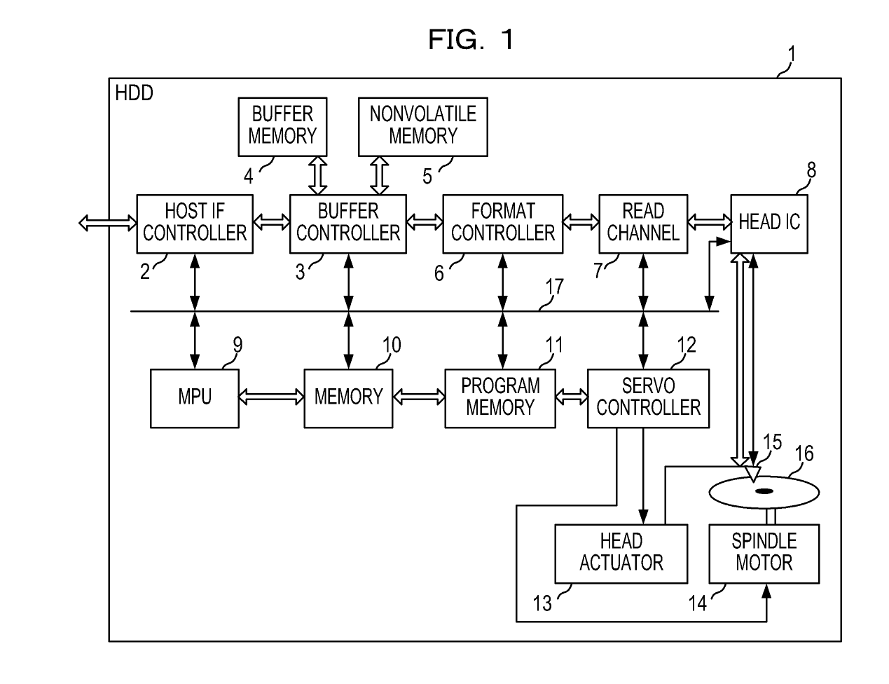

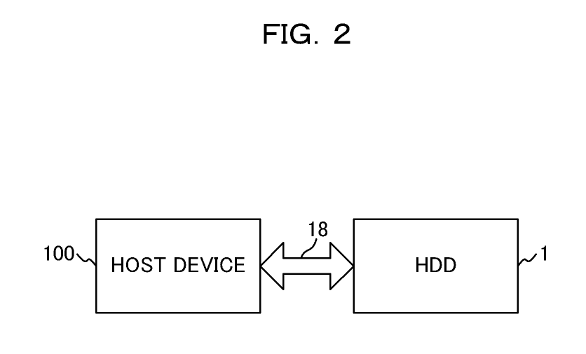

First, the HDD will be described. FIG. 1 is the block diagram illustrating the structure of the HDD. FIG. 2 is the block diagram illustrating the HDD and the host devices connected with the HDD.

HDD 1 includes: host interface controller 2, buffer controller 3, buffer memory 4, nonvolatile memory 5, format controller 6, read channel 7, head IC 8, micro processing unit (MPU) a judgment unit, an internal information management unit, counter 9, memory 10, program memory 11, servo controller 12, head actuator 13, spindle motor 14, read-write head 15, disk medium 16 (in other words, a storage area), and common bus 17.

Host interface controller 2 is a control circuit for controlling a host interface (not illustrated in FIG. 1.) Buffer controller 3 is a control circuit for controlling buffer memory 4 and nonvolatile memory 5. Buffer memory 4 temporarily stores data to be read from or to be written on disk medium 16. Nonvolatile memory 5 stores the internal information of HDD 1. Format controller 6 is a control circuit for controlling formats. Read channel 7 modulates or demodulates data to be read from or written on disk medium 16 with read-write head 15. Head IC 8 amplifies signals read from disk medium 16 with read-write head 15. MPU 9 executes processes for controlling HDD 1. Memory 10 stores data and programs for controlling HDD 1. Program memory 11 is a nonvolatile memory such as FROM for storing programs for controlling HDD 1. Servo controller 12 controls behaviors of head actuator 13 and spindle motor 14. Head actuator 13 drives read-write head 15. Spindle motor 14 spins disk medium 16. Read-write head 15 writes data on disk medium 16 and reads data written on disk medium 16. Common bus 17 is a bus on which host interface controller 2, buffer controller 3, format controller 6, read channel 7, head IC 8, MPU 9, memory 10, program memory 11 and servo controller 12 are connected.

As illustrated in FIG. 2, HDD 1 according to the first embodiment is connected with host device 100 such as a personal computer through host interface 18 (not illustrated.)

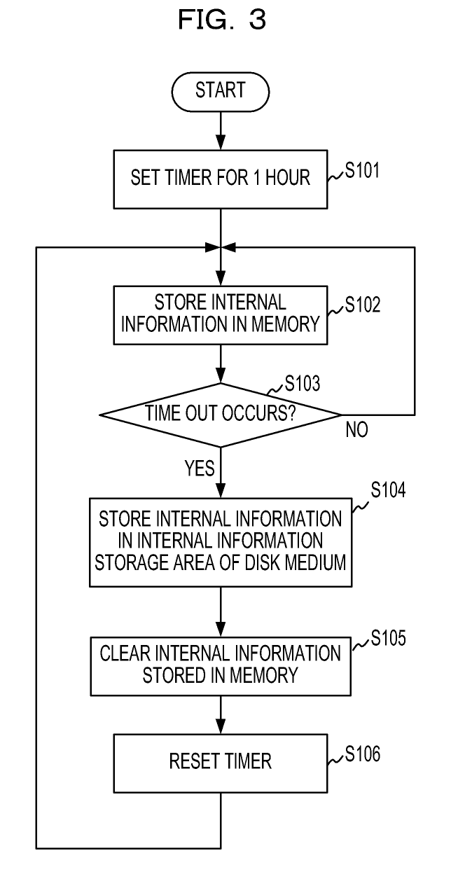

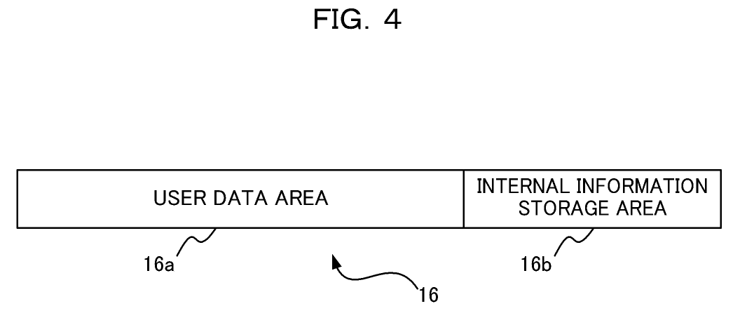

Secondly, the behavior of the HDD according to the first embodiment will be disclosed. FIG. 3 is the flow chart illustrating the storing process of the internal information according to the first embodiment. FIG. 4 illustrates the internal information storage area according to the first embodiment.

MPU 9 sets a timer for one hour in a counting step, S101. In step S102, MPU 9 gathers the internal information such as the number of commands for reading and writing, and counts up the numbers. The aggregated numbers are stored in memory 10. Temperatures of HDD 1 are stored in the memory at certain intervals to determine a mean temperature, the highest temperature, and the lowest temperature in a period of one hour set in the timer.

Then MPU 9 judges whether one hour has lapsed from when the timer is set in a judging step, S103.

If the time elapsed is one hour from when the timer is set (step S103, YES), MPU 9 stores the gathered internal information in internal information storage area 16b in an internal information managing step, S104. Now, the internal information recoding area will be described. Internal information recoding area 16b is an area on disk medium 16, which is different from user data area 16a on disk medium 16. Internal information storage area 16b may be provided in nonvolatile memory 5 of HDD 1 according to the embodiments of the present technique. MPU 9 determines the mean temperature, the highest temperature, and the lowest temperature from among the temperatures stored in the memory at certain intervals in the period of one hour when storing the internal information.

After storing the internal information in internal information storage area 16b, MPU 9 deletes the internal information stored in memory 10 in step S105. Then MPU resets the timer for one-hour in a counting step, S106. In step S102, MPU 9 gathers and stores the internal information in memory 10 again.

If one hour has not lapsed from when the timer was set (step S103, NO), MPU 9 gathers and stores the internal information in memory 10 again in step S102.

As described above, the causal relation between an error and its cause is determined readily by storing the internal information at the given intervals. In the process illustrated in FIG. 3, the timer is set for one-hour. However, a period of the time is variable. The interval of storing the internal information may be changed by host device 100. Alternatively, a density of each piece of the gathered internal information may be changed by changing the storing interval. For example, the number of the error occurrences may be stored at intervals of one hour, and the temperatures, the number of sectors from which data are read, the number of sectors on which data are written, and the number of the external shocks may be stored at intervals of three hours. As a result, a capacity of internal information storage area 16b is saved and more logs of the internal information may be stored by changing the storing interval of the each piece of the gathered internal information according to their importance. Each piece of the internal information stored in internal information storage area 16b may be deleted after an expiration of the given period of time.

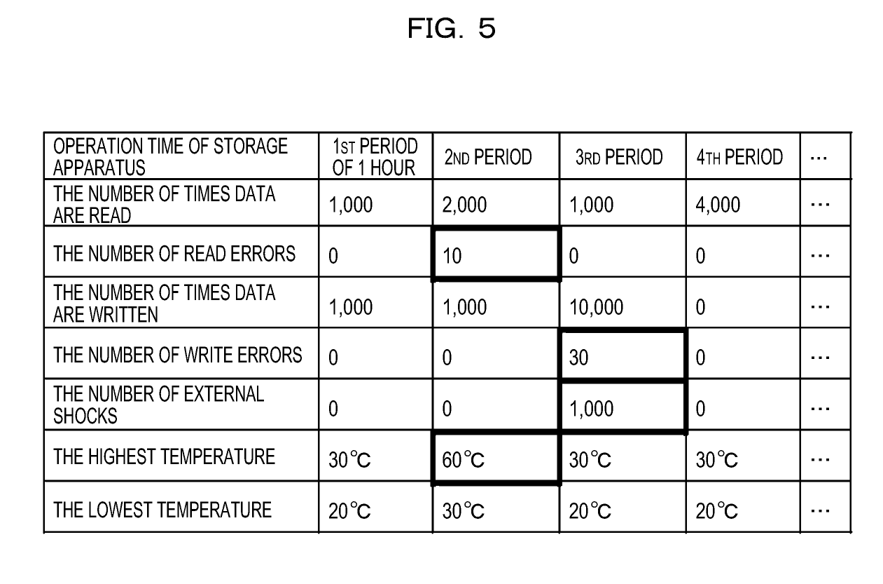

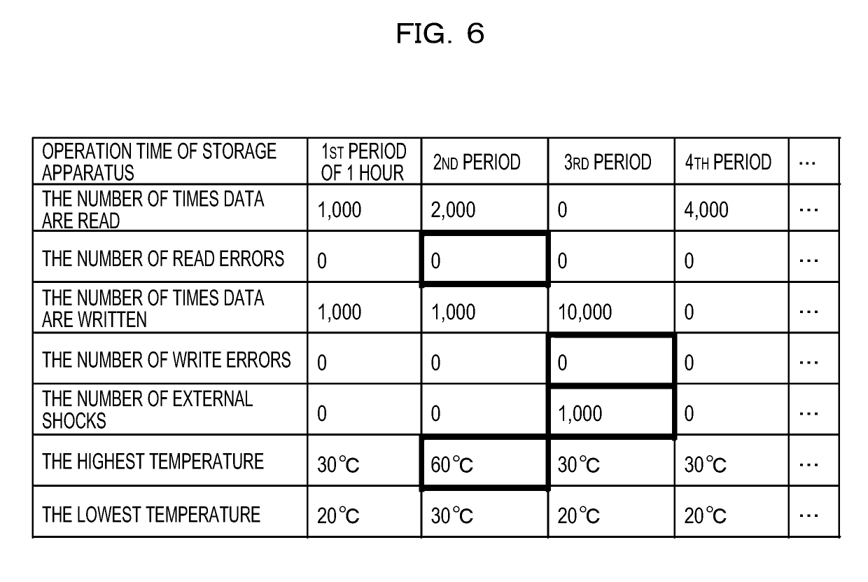

Next, the internal information stored in internal information storage area 16b and a function of the internal information will be described. FIG. 5 illustrates the example of the stored internal information before the error correcting measure according to the first embodiment is taken. FIG. 6 illustrates the example of the stored internal information after the error correcting measure according to the first embodiment is taken.

Internal information storage area 16b stores each piece of the internal information gathered in each one-hour period of the storage apparatus operation time. Each piece of the gathered internal information is provided period of time. According to the internal information provided in FIG. 5, read errors occurred 10 times in the second period and write errors occurred 30 times in the third period. The temperature of HDD 1 reached 60 degree Centigrade at the maximum in the second period. External shocks were detected 1,000 times in the third period. The internal information illustrated in FIG. 5 leads to the conclusion that the highest temperature of HDD 1 and the external shocks may be highly attributed to the read errors and the write errors, respectively. MPU 9 may be configured to judge that, for example, a piece of the internal information with the greatest differential between its mean value in a period during which the error is caused is a cause of the error.

If the temperature and the external shocks are judged as the cause of the errors, an error correction measure will be taken against the cause. The effect of the error correction measure may be confirmed by comparing the internal information stored before the error correction measure is taken as illustrated in FIG. 5 with the internal information stored after the error correction measure is taken, as illustrated in FIG. 6. According to the internal information illustrated in FIG. 6, no read error is caused in the period during which the temperature of HDD 1 reaches 60 degree Centigrade. Moreover, no write error is caused in the period during which the external shocks are detected 1,000 times. Consequently, the effect of the error correction measure may be confirmed readily.

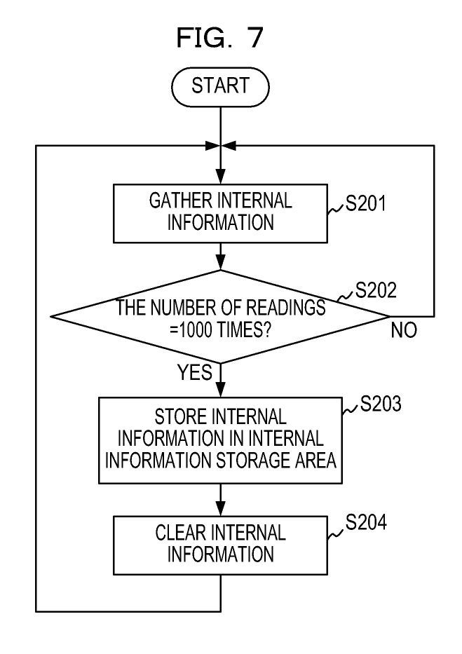

In the first embodiment, the condition for storing the internal information in internal information storage area 16b is a lapse of a given period of time. In the second embodiment, the condition for storing the internal information is a value of each piece of the internal information. More specifically, the internal information is stored in internal information storage area 16b when a value of each piece of the internal information reaches a given value in the second embodiment. The HDD in the second embodiment includes the same structure as the HDD in the first embodiment. However, the storing process of the internal information is different because the storing condition is different. FIG. 7 is the flow chart illustrating the storing process of the internal information according to the second embodiment. In the second embodiment, the storing condition of the internal information is that the number of times data are read reaches 1,000.

MPU 9 gathers the internal information such as the numbers of commands for reading and writing issued to HDD 1, and counts up and stores the gathered information in memory 10 in step S201. The temperatures of HDD 1 are stored in the memory at the given intervals until the configured condition is satisfied to determine the mean temperature, the highest temperature, and the lowest temperature.

Then MPU 9 judges whether the configured condition is satisfied, more specifically, whether the number of times data are read reaches 1,000 in a judging step, S202.

If the number of times data are read reaches 1,000 (step S202, YES), MPU 9 stores the gathered internal information in internal information storage area 16b in an internal information managing step, S203. At the same time, MPU 9 determines the mean temperature, the highest temperature, and the lowest temperature from among the temperatures stored in the memory at the given intervals until the storing condition is satisfied.

After storing the internal information in internal information storage area 16b, MPU 9 deletes the internal information stored in memory 10 in step S204. Then MPU 9 gathers and stores the internal information in memory 10 again in step S201.

If the number of times data are read does not reach 1,000 (step S202, NO), MPU 9 gathers and stores the internal information in memory 10 again in step S201.

HDD1 according to the second embodiment stores the internal information based on the numeric value of the internal information as described above. Alternatively, for HDD 1 according to the second embodiment, the density of the gathered information may be changed by changing the value of the storing condition instead of deleting the aggregated value of the storing condition. For example, the number of errors may be stored every time the number of times data are read reaches 1,000. And the temperatures, the number of sectors from which data are read, the number of sectors on which data are written, and the number of external shocks may be stored every time the number of time data are read reaches 3,000. Therefore, the storing timing of the gathered information may be changed according to the importance of each piece of the information. Consequently, the capacity of the internal information storage area is saved and more logs of the internal information may be stored.

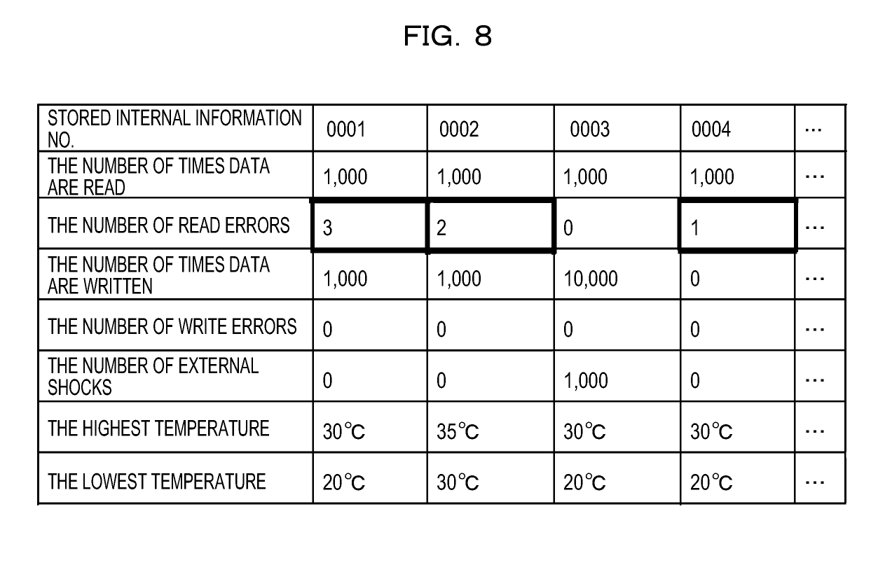

Next, the stored internal information according to the second embodiment will be disclosed. FIG. 8 illustrates the example of the stored internal information according to the second embodiment.

As illustrated in FIG. 8, each piece of the internal information gathered until the storing condition is satisfied is provided according to a stored internal information number, which represents the number of times these pieces are stored. Thus, the number of errors may be determined based on the operation or a status of HDD 1, not a certain period of time, by setting the condition. More specifically, the cause of the errors may be detected by configuring a highly possible cause of errors as the storing condition.

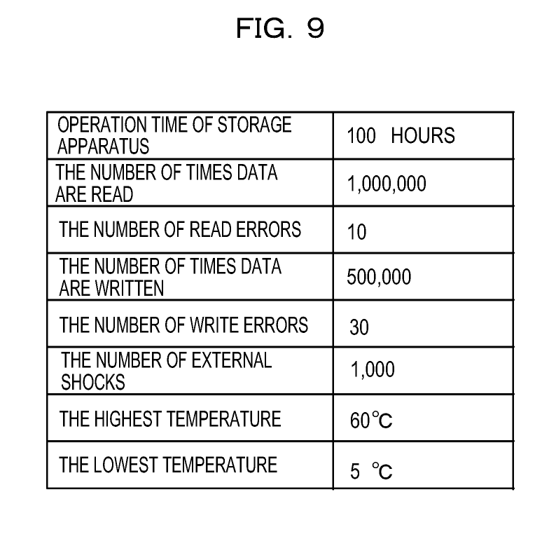

FIG. 9 illustrates a compensative example of internal information. The internal information includes operating time of the storage apparatus, the number of times data are read, the number of errors caused in reading, the number of times data are written, the number of errors caused in writing, the number of times external shocks are detected, and highest and lowest temperatures of the storage apparatus. The internal information excluding the highest temperature and the lowest temperature are counted up from when the storage apparatus is operated the first time. According to the internal information illustrated in FIG. 9, the storage apparatus detects errors 10 times in reading and 30 times in writing. The external shocks possibly causing the errors are detected 1,000 times. The temperature of the storage apparatus reaches 60 degree Centigrade at the maximum. However, which of the external shock or the temperature causes so many read errors and write errors is not determined according to the internal information. The present technique is designed to solve this problem.

According to the present technique used for the embodiments described above, the given condition triggers the storage apparatus to store the internal information as logs. Alternatively, the period of time and the value of the internal information may be combined as the storing condition. More specifically, a combination of the given period of time and the given value of each piece of the internal information may be configured as the storing condition of the internal information. HDD 1 executes the processes relating to the present technique in the first and second embodiments. Alternatively, host device 100 may gather the internal information and execute the processes, or a device connected with a network through host device 100 may execute the processes relating to the present technique.

According to the present technique, the causal relation between the internal information and errors may be judged easily.

The present technique may be implemented in various embodiments without departing from features and advantages of this technique. Accordingly, the embodiments of the present technique, as set forth herein, are intended to be illustrative, not limiting. The scope of the present technique is defined in the claims and statements made in the specification of the present application do not necessarily limit any of the various claimed technique. It should be understood that all variations, modifications, alternations, and reformations within the scope of the claims maybe resorted to, falling within the scope of the present technique.

All examples and conditional language recited herein are intended for pedagogical purposes to aid the reader in understanding the invention and the concepts contributed by the inventor to furthering the art, and are to be constructed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A storage apparatus storing data in a storage area, comprising:
a judgment unit that judges whether a preconfigured given condition is satisfied; and
an internal information management unit that associates the satisfied preconfigured condition with internal information relating to an operation or a status of the storage apparatus and manages the condition and the internal information when the judgment unit judges that the given condition is satisfied.

2. The storage apparatus according to claim 1, further comprising:
a counter which counts elapsed time,
wherein the judgment unit judges that the preconfigured condition is satisfied when the time counted by the counter reaches a preconfigured given time, and the internal information management unit associates the preconfigured given time with the internal information gathered until the time reaches the preconfigured given time and that manages the value and the internal information.

3. The storage apparatus according to claim 1,
wherein the judgment unit judges that the preconfigured given condition is satisfied when a value of the internal information reaches a preconfigured given value, and the internal information management unit associates the preconfigured given value with the internal information gathered until the value of the internal information reaches the given value, and manages the value and the internal information.

4. The storage apparatus according to claim 1,
wherein the internal information includes, at least, one or more from among read error information, write error information, external shock detection information and temperature information.

5. The storage apparatus according to claim 1,
wherein the internal information management unit stores the internal information in a storage area that is different from the storage area in which the data are stored.

6. The storage apparatus according to claim 2,
wherein the internal information management unit stores the internal information in a storage area that is different from the storage area in which the data are stored.

7. The storage apparatus according to claim 3,
wherein the internal information management unit stores the internal information in a storage area that is different from the storage area in which the data are stored.

8. The storage apparatus according to claim 2,
wherein the internal information management unit changes a density of internal information to be managed based on the preconfigured given time.

9. The storage apparatus according to claim 3,
wherein the internal information management unit changes a density of internal information to be managed based on the preconfigured given value.

10. A method for storing internal information of the storage apparatus that stores data in a storage area, the method comprising:
judging whether a preconfigured given condition is satisfied; and
associating the satisfied condition with the internal information relating to an operation or a status of the storage apparatus, and managing the condition and the internal information.

11. The method for storing the internal information according to claim 10, further comprising:
counting a lapse of time,
wherein the judging operation judges that the given condition is satisfied when the time counted in the counting operation reaches a preconfigured given time, and the internal information managing operation associates the given time with the internal information gathered until the counted time reaches the given time, and manages the time and the internal information.

12. The method for storing the internal information according to claim 10,
wherein the judging operation judges that the given condition is satisfied when a value of the internal information reaches a preconfigured given value, and the internal information managing operation associates the given value with the internal information gathered until the value reaches the preconfigured value.

13. The method for storing the internal information according to claim 10,
wherein the internal information managing operation stores the internal information in a storage area that is different from the storage area in which the data are stored.

14. The method for storing the internal information according to claim 11,
wherein the internal information managing operation changes the information density of the internal information to be managed according to the given time.

15. The method for storing the internal information according to claim 12,
wherein the internal information managing operation changes the information density of the internal information to be managed according to the predefined value.
